(19) United States
(12) Patent Application Publication
(10) Pub. No.: US 2013/0018218 A1
(43) Pub. Date: Jan. 17, 2013

(54) Systems, Devices, Components and Methods for Bone Conduction Hearing Aids

(71) Applicants: Markus C. Haller, Gland (CH); Nicholas F. Pergola, Arvada, CO (US); James F. Kasic, Boulder, CO (US)

(72) Inventors: Markus C. Haller, Gland (CH); Nicholas F. Pergola, Arvada, CO (US); James F. Kasic, Boulder, CO (US)

(73) Assignee: Sophono, Inc., Boulder, CO (US)

(21) Appl. No.: 13/550,581

(22) Filed: Jul. 16, 2012

Related U.S. Application Data
(60) Provisional application No. 61/507,713, filed on Jul. 14, 2011.
(60) Provisional application No. 61/507,720, filed on Jul. 14, 2011.
(60) Provisional application No. 61/507,725, filed on Jul. 14, 2011.
(60) Provisional application No. 61/507,729, filed on Jul. 14, 2011.
(60) Provisional application No. 61/507,734, filed on Jul. 14, 2011.

(51) Int. Cl. H04R 25/00

(52) U.S. Cl. 600/25

(57) ABSTRACT

Various embodiments of systems, devices, components, and methods are disclosed for hearing devices and systems.

### RELATED APPLICATIONS

This application claims priority and other benefits from each of: (1) U.S. Provisional Patent Application Ser. No. 61/507,713 entitled “Magnetic Implant Arrays for Heating Devices” to Pergola filed Jul. 14, 2011; (2) U.S. Provisional Patent Application Ser. No. 61/507,720 entitled “Hearing Aid Attachments and Abutments ” to Pergola filed Jul. 14, 2011; (3) U.S. Provisional Patent Application Ser. No. 61/507,725 entitled “Active Antisepsis and/or Osseointegration for Bone-Anchored Hearing Aid Devices ” to Pergola filed Jul. 14, 2011; (4) U.S. Provisional Patent Application Ser. No. 61/507,729 entitled “Active Cancellation for a Bone Conduction Hearing Device ” to Pergola filed Jul. 14, 2011, and (5) U.S. Provisional Patent Application Ser. No. 61/507,734 entitled “Magnetic Spacers ” to Pergola filed Jul. 14, 2011. Each of the foregoing patent applications is hereby incorporated by reference herein, each in its respective entirety.

### FIELD OF THE INVENTION

Various embodiments of the invention described herein relate to the field of systems, devices, components, and methods for bone conduction or bone-anchored hearing aid devices.

### BRIEF DESCRIPTION OF THE DRAWINGS

Different aspects of the various embodiments will become apparent from the following specification, drawings and claims in which:

FIGS. 1(a), 1(b) and 1(c) show side cross-sectional schematic views of selected embodiments of SOPHONO ALPHA 1, BAHA and AUDIANT bone conduction hearing aids, respectively;

FIG. 2(a) shows one embodiment of implantable bone plate 20 per FIG. 1(a)

FIG. 2(b) shows one embodiment of a SOPHONO® ALPHA 1® hearing aid 10;

FIG. 3(a) shows one embodiment of a functional electronic and electrical block diagram of hearing aid 10 shown in FIGS. 1(a) and 2(b);

FIG. 3(b) shows one embodiment of a wiring diagram for a SOPHONO ALPHA 1 hearing aid manufactured using an SA3286 DSP;

FIG. 4 shows one embodiment of an implantable magnetic array 20 for use in conjunction with hearing aid 10;

FIGS. 5(a) through 5(aa) show various embodiments of hearing aid attachments and abutments;

FIG. 6 shows one embodiment of a bone anchored hearing device 10 with a percutaneous bone screw 15 coated with an antisepsis and/or osseointegration-promoting material or coating 23;

FIG. 7(a) shows a block diagram of a hearing instrument or device 10.

FIG. 7(b) shows a block diagram of a hearing instrument 10 that allows some amplified sound to leak back to microphone 85;

FIG. 7(c) shows a component that provides input used to adjust or set βₘ;

FIG. 7(d) illustrates one embodiment of device 10 where accelerometer 11 is positioned next to microphone 85, and

FIGS. 8(a) through 8(o) show various embodiments of spacers or base plates 50 for use in conjunction with magnetically coupled hearing device 10.

The drawings are not necessarily to scale. Like numbers refer to like parts or steps throughout the drawings.

### DETAILED DESCRIPTIONS OF SOME EMBODIMENTS

Described herein are various embodiments of systems, devices, components and methods for bone conduction and/or bone-anchored hearing aids.

A bone-anchored hearing device (or “BAHD”) is an auditory prosthetic device based on bone conduction having a portion or portions thereof which are surgically implanted. A BAHD uses the bones of the skull as pathways for sound to travel to a patient's inner ear. For people with conductive hearing loss, a BAHD bypasses the external auditory canal and middle ear, and stimulates the still-functioning cochlea via an implanted metal post. For patients with unilateral hearing loss, a BAHD uses the skull to conduct the sound from the deaf side to the side with the functioning cochlea. In most BAHA systems, a titanium post or plate is surgically embedded into the skull with a small abutment extending through and exposed outside the patient's skin. A BAHD sound processor attaches to the abutment and transmits sound vibrations through the external abutment to the implant. The implant vibrates the skull and inner ear, which stimulates the nerve fibers of the inner ear, allowing hearing. A BAHD device can also be connected to an FM system or iPod by means of attaching a miniaturized FM receiver or Bluetooth connection thereto.

BAHD devices manufactured by Cochlear of Sydney, Australia, and Opticon of Smoerum, Sweden. Sophono of Boulder, Colo. manufactures an Alpha 1 magnetic hearing aid device, which attaches by magnetic means behind a patient's ear to the patient's skull by coupling to a magnetic or magnetized plate implanted in the patient's skull beneath the skin.

Surgical procedures for implanting such posts or plates are relatively straightforward, and are well known to those skilled in the art. See, for example, “Alpha I (S) & Alpha I (M) Physician Manual—REV A S0300-00” published by Sophono, Inc. of Boulder, Colo., the entirety of which is hereby incorporated by reference herein.

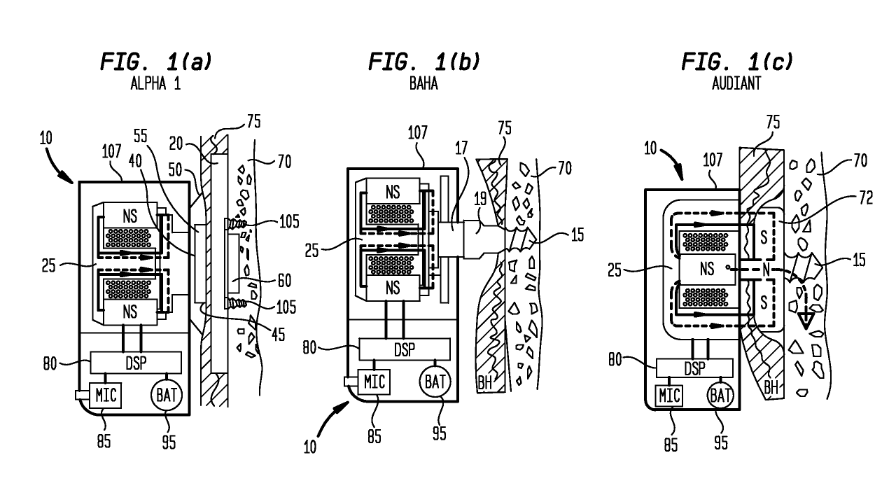

FIGS. 1(a), 1(b) and 1(c) show side cross-sectional schematic views of selected embodiments of SOPHONO ALPHA 1, BAHA and AUDIANT bone conduction hearing aids, respectively. Note that FIGS. 1(a), 1(b) and 1(c) are not necessarily to scale.

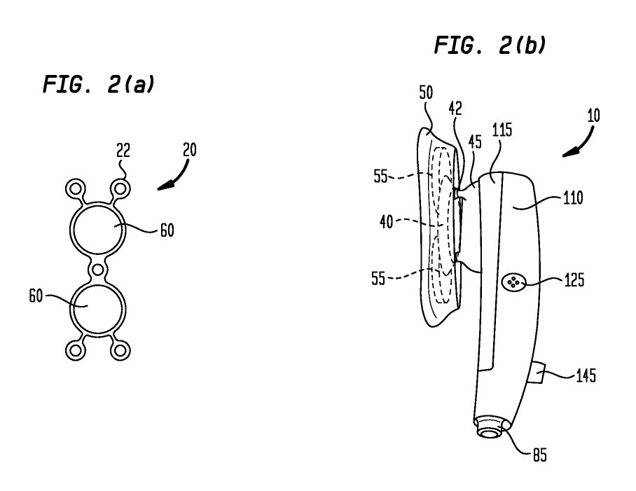

In FIG. 1(a), magnetic hearing aid device 10 comprises housing 107, electromagnetic/bone conduction (“EM”) transducer 25 with corresponding magnets and coils, digital signal processor (“DSP”)80, battery 95, magnetic spacer 50, magnetic implantable plate 20, and bone screws 105. According to one embodiment, and as shown in FIG. 1(a), implantable plate 20 is a frame 22 (see FIG. 2(a)) formed of a biocompatible metal such as titanium that is configured to have disposed therein or have attached thereto internal implantable magnets or magnetic members 60 that are configured to couple magnetically to one or more corresponding external magnetic members or magnets 55 mounted or otherwise forming a portion of spacer 50, which in turn is operably coupled to EM transducer 25 and metal disc 40. DSP 80 is configured to drive EM transducer 25 and spacer 50/metal disc 40 in accordance with external audio signals picked up by microphone 85. DSP 80 and EM transducer 25 are powered by battery 95, which according to one embodiment is a zinc-air battery.

As further shown in FIG. 1(a), implantable plate 20 is attached to patient's skull 70, and is separated from metal disc 40/spacer 50 by patient's skin 75. Hearing aid device 10 of FIG. 1(a) is thus coupled magnetically and mechanically to plate 20 implanted in patient's skull 70, thereby permitting the transmission of audio signals originating in DSP 80 and EM transducer 25 to the patient's inner ear via skull 70.

FIG. 1(b) shows another embodiment of hearing aid 10, which is a BAHA® device comprising housing 107, electromagnetic/bone conduction (“EM”) transducer 25 with corresponding magnets and coils, digital signal processor (“DSP”)80, battery 95, external post 17, internal bone anchor 15, and abutment member 19. In one embodiment, and as shown in FIG. 1(b), internal bone anchor includes a bone screw formed of a biocompatible metal such as titanium that is configured to have disposed thereon or have attached thereto abutment member 19, which in turn may be configured to mate mechanically or magnetically with external post 17, which in turn is operably coupled to EM transducer 25. DSP 80 is configured to drive EM transducer 25 and external post 17 in accordance with external audio signals picked up by microphone 85. DSP 80 and EM transducer 25 are powered by battery 95, which according to one embodiment is a zinc-air battery. As shown in FIG. 1(b), implantable bone anchor 15 is attached to patient's skull 70, and is attached to external post 17 through abutment member 19, either mechanically or by magnetic means. Hearing aid device 10 of FIG. 1(b) is thus coupled magnetically and/or mechanically to bone anchor 15 implanted in patient's skull 70, thereby permitting the transmission of audio signals originating in DSP 80 and EM transducer 25 to the patient's inner ear via skull 70.

FIG. 1(c) shows another embodiment of hearing aid 10, which is an AUDIANT®-type device, where an implantable magnetic plate 72 is attached by means of bone anchor 15 to patient's skull 70. Internal bone anchor 15 includes a bone screw formed of a biocompatible metal such as titanium, and has disposed thereon or attached thereto implantable magnetic member 72, which couples magnetically through patient's skin 75 to EM transducer 25. DSP 80 is configured to drive EM transducer 25 in accordance with external audio signals picked up by microphone 85. Hearing aid device 10 of FIG. 1(c) is thus coupled magnetically to bone anchor 15 implanted in patient's skull 70, thereby permitting the transmission of audio signals originating in DSP 80 and EM transducer 25 to the patient's inner ear via skull 70.

FIG. 2(a) shows one embodiment of implantable bone plate 20 per FIG. 1(a), where frame 22 has disposed thereon or therein implantable magnets 60. The two magnets of FIG. 2(a) permit hearing aid 10 to be placed in different positions on patient's skull 70 according to the position desired by the patient. FIG. 2(b) shows one embodiment of a SOPHONO® ALPHA 1® hearing aid 10 that is configured to operate in accordance with implantable bone plate 20 of FIG. 2(a). As shown, hearing aid 10 of FIG. 2(b) comprises upper housing 110, lower housing 115, spacer or bone plate 50, external magnets 55 disposed within spacer 50, EM transducer diaphragm 45, posts 42 and metal disk 40 connecting EM transducer 25 to spacer 50, programming port/socket 125, program switch 145, and microphone 85. Not shown in FIG. 2(b) are other aspects of the embodiment of hearing aid 10, such as volume control 120, battery compartment 130, battery door 135, battery contacts 140, direct audio input (DAI) 150, and hearing aid circuit board 155 upon which various components are mounted, such as DSP 80.

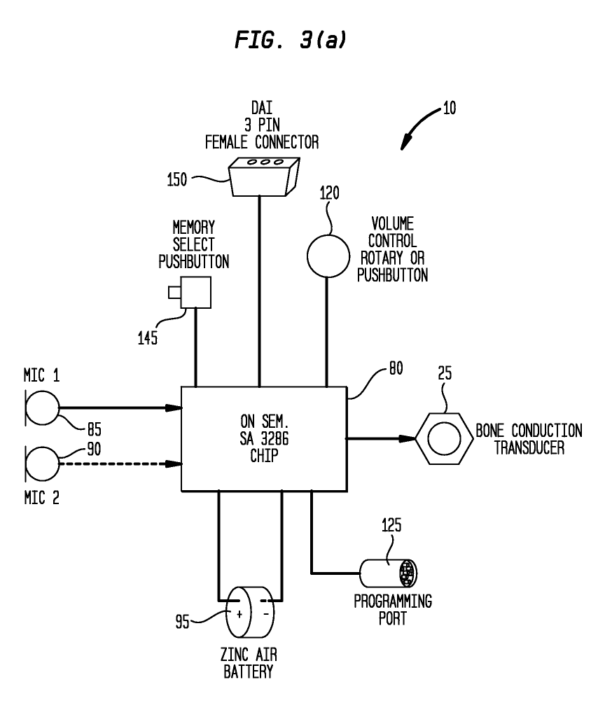

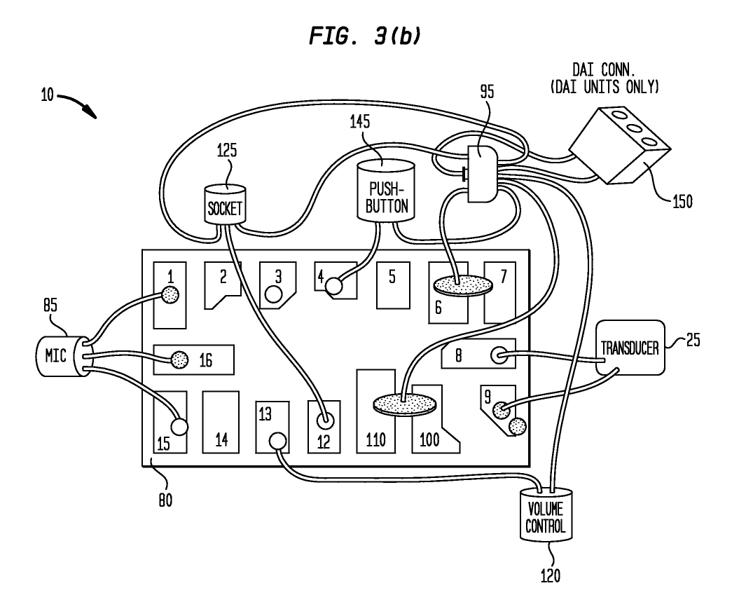

FIG. 3(a) shows one embodiment of a functional electronic and electrical block diagram of hearing aid 10 shown in FIGS. 1(a) and 2(b). In the block diagram of FIG. 3(a), DSP 80 is a SOUND DESIGN TECHNOLOGIES® SA3286 INSPIRA EXTREME® DIGITAL DSP, for which data sheet 48550-2 dated March 2009, filed on even date herewith in an accompanying Information Disclosure Statement (“IDS”), is hereby incorporated by reference herein in its entirety. The audio processor for the SOPHONO ALPHA 1 hearing aid is centered around DSP chip 80, which provides programmable signal processing. The signal processing may be customized by computer software which communicates with the Alpha through programming port 125. According to one embodiment, the system is powered by a standard zinc air battery 95 (i.e. hearing aid battery), although other types of batteries are contemplated. The SOPHONO ALPHA 1 hearing aid detects acoustic signals using a miniature microphone 85. A second microphone 90 may also be employed, as shown in FIG. 3(a). The SA 3286 chip supports directional audio processing with second microphone 90 to enable directional processing. Direct Audio Input (DAI) connector 150 allows connection of accessories which provide an audio signal in addition to or in lieu of the microphone signal. The most common usage of the DAI connector is FM systems. The FM receiver may be plugged into DAI connector 150. Such an FM transmitter can be worn, for example, by a teacher in a classroom to ensure the teacher is heard clearly by a student wearing hearing aid 10. Other DAI accessories include an adapter for a music player, a telecoil, or a Bluetooth phone accessory. According to one embodiment, DSP 80 or SA 3286 has 4 available program memories, allowing a hearing health professional to customize each of 4 programs for different listening situations. The Memory Select Pushbutton 145 allows the user to choose from the activated memories. This might include special frequency adjustments for noisy situations, or a program which is Directional, or a program which uses the DAI input.

FIG. 3(b) shows one embodiment of a wiring diagram for a SOPHONO ALPHA 1 hearing aid manufactured using the foregoing SA3286 DSP. Note that the various embodiments of hearing aid 10 are not limited to the use of a SA3286 DSP, and that any other suitable CPU, processor, controller or computing device may be used. According to one embodiment, DSP 80 is mounted on a printed circuit board 155 disposed within housing 110 and /or housing 115 of hearing aid 10 (not shown in the Figures).

In some embodiments, the microphone incorporated into hearing aid 10 is an 8010T microphone manufactured by SONION®, for which data sheet 3800-3016007, Version 1 dated December, 2007, filed on even date herewith in the accompanying IDS, is hereby incorporated by reference herein in its entirety. Other types of microphones, including other types of capacitive microphones, are also contemplated.

In still further embodiments, the electromagnetic transducer 25 incorporated into hearing aid 10 is a VKH3391W transducer manufactured by BMH-Tech® of Austria, for which the data sheet filed on even date herewith in the accompanying IDS is hereby incorporated by reference herein in its entirety. Other types of EM transducers are also contemplated.

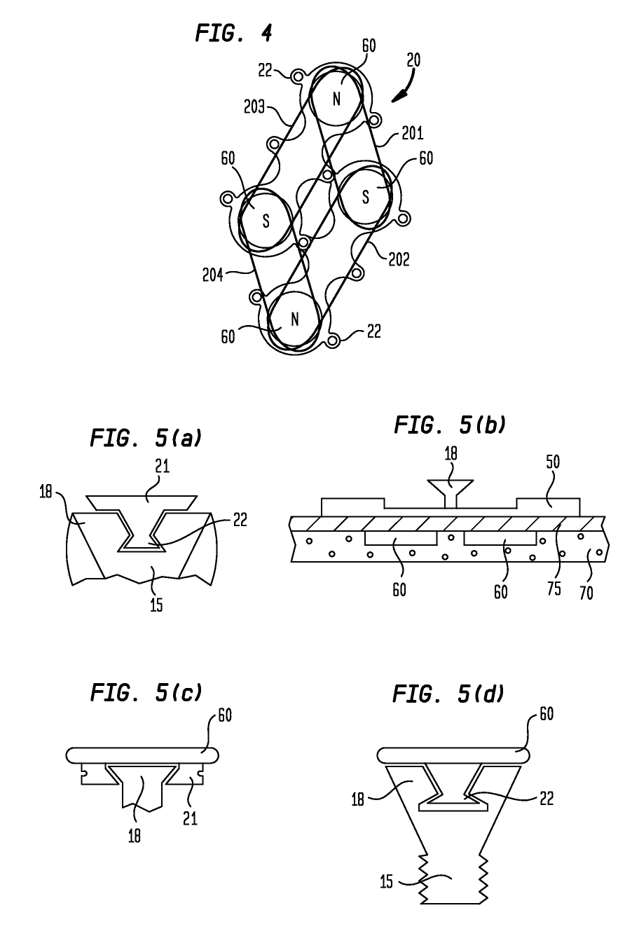

Referring now to FIG. 4, there is shown one embodiment of an implantable magnetic array 20 for use in conjunction with hearing aid 10. In the embodiment shown in FIG. 4, frame 22 is configured to hold two different pairs of magnets 60 that provide different magnetic field orientations so as to permit a patient or user to magnetically couple hearing aid 10 to implantable array 20 in any of four different positions denoted by numerals 201, 202, 203 and 204 in FIG. 4. Magnetic implant array 20 is preferably configured to be affixed to skull 70 under patient's skin 75. In one aspect, affixation of array 20 to skull 75 is by direct means, such as by a screw 105. Other means of attachment known to those skilled in the art are also contemplated, however. As discussed above, an external magnetic attachment mechanism such as external magnets 55 are placed over skin 75 and retained against skull 70 by means of magnetic attraction.

In certain cases it may be advantageous to implant additional magnets 60, for instance in patients with very thin skin over the implant, or in additional more widespread locations. A magnetic spacer may also be placed between magnets 60 and 55 to facilitate rotation between locations, or to modulate magnetic attraction or force, so that no one location becomes sore. Magnets 55 and 60 may also be configured in various different orientations in different pole positions to effect different or variable magnetic coupling. For example, the polarities of magnets 55 and 60 may face facing in the same or opposite directions, and/or in various combinations thereof. The geometries of implant 20 and external magnets 55 and base plate 50 may also be selected so that frame(s) 22, magnets 60, and magnets 60 have center-to-center distances between magnets that are essentially equidistant.

According to some embodiments, magnets 60 are substantially disc-shaped, although other shapes are contemplated. Illustrative diameters of such magnets 60 range between about 8 mm and about 20 mm, and have thicknesses ranging between about 1 mm and about 4 mm. A center-to-center spacing of magnets 60 in frame 22 ranges between about 1.5 cm and about 2.5 cm, with a preferred spacing of about 2 cm. Rare earth magnets with high magnetic force are preferred for magnets 60. A system adhesion force accomplished with two implanted magnets 60 and a corresponding pair of external magnets 55 located in base plate 50 may range, by way of example, between about 0.5 Newtons and about 3 Newtons, with a preferred range of 1 Newton to 2.5 Newtons. Variability in adhesion force can be accomplished solely with different base plate configurations (see below), while implanted magnet(s) 60, once implanted have a fixed adhesion force associated therewith.

Implant 20 can even be implanted upside down, as then the North magnetic pole would become the South magnetic pole, but also the South magnetic pole would become the North magnetic pole from a magnetic point of view. As base plate 50 has rotational freedom, the system of adhesion and function of device 10 would still work as intended.

Those skilled in the art will now understand that many different permutations, combinations and variations of implant array 20 fall within the scope of the various embodiments. For example, 2, 3, 4, 5, 6, 7, 8, 9 or more magnets 60 may be employed in frame 22. Frame 22 may be configured in star-shaped, hexagonally-shaped, pentagonally-shaped, triangle-shaped, rectangularly-shaped, and many other geometric configurations. Magnets 60 may also be enclosed within frame 22 by laser welding, for example.

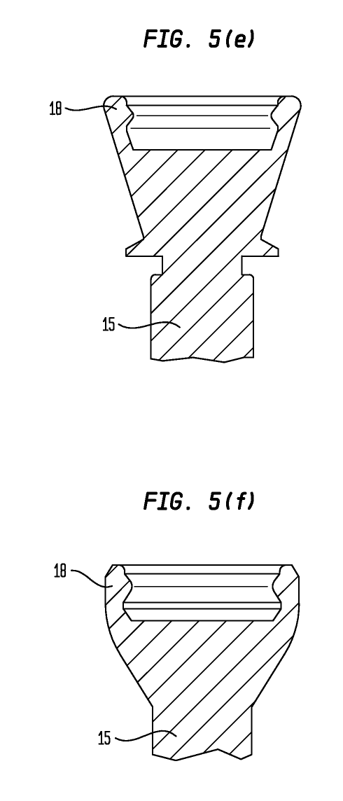

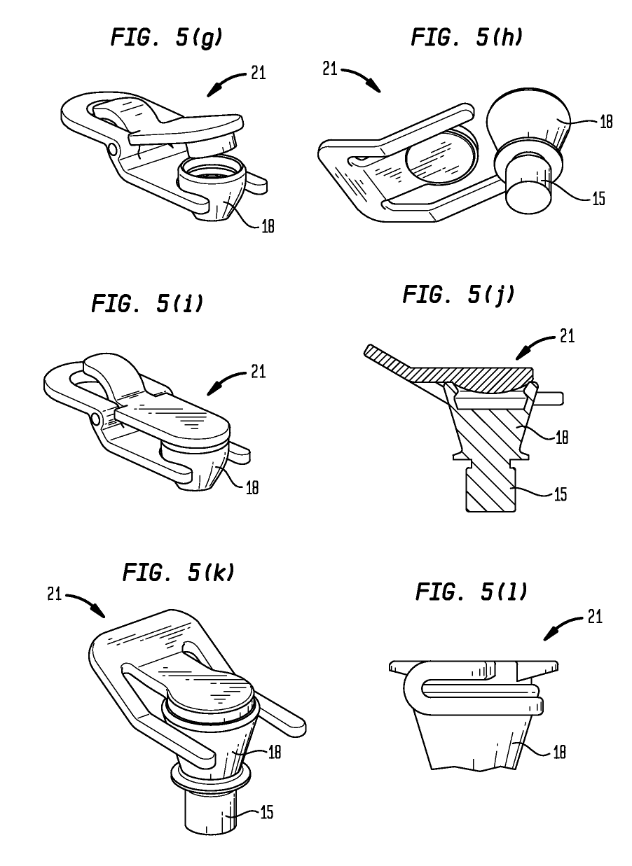

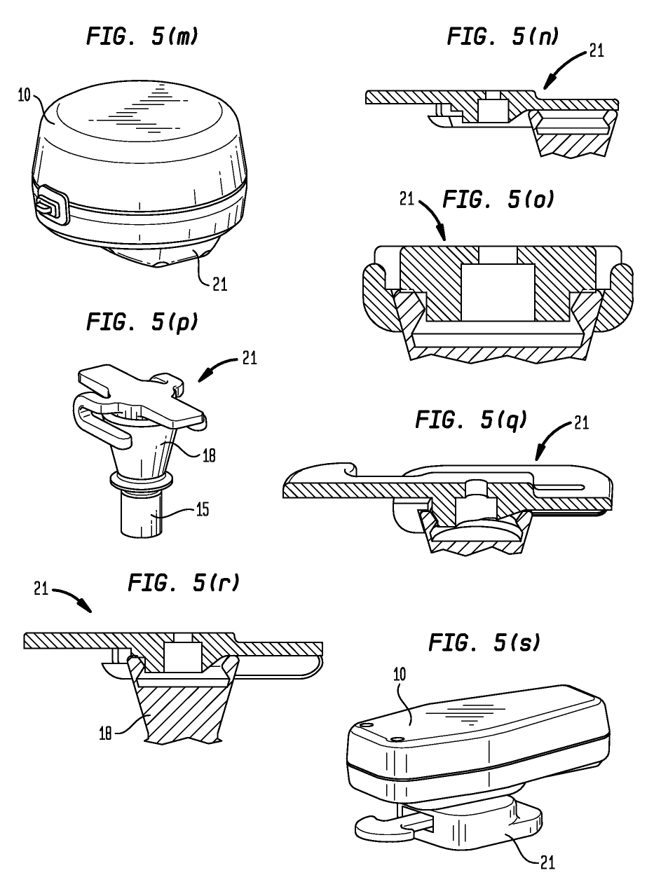

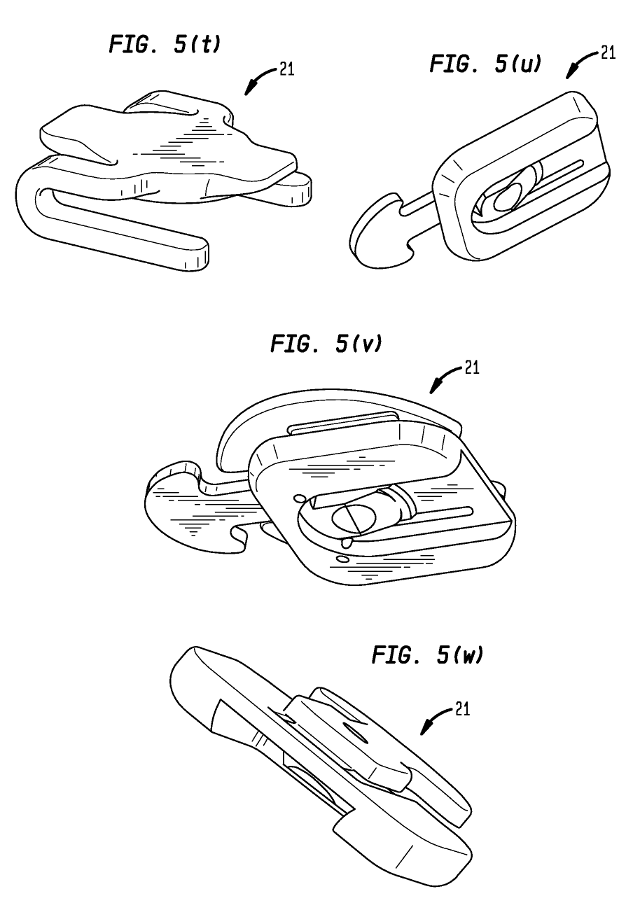

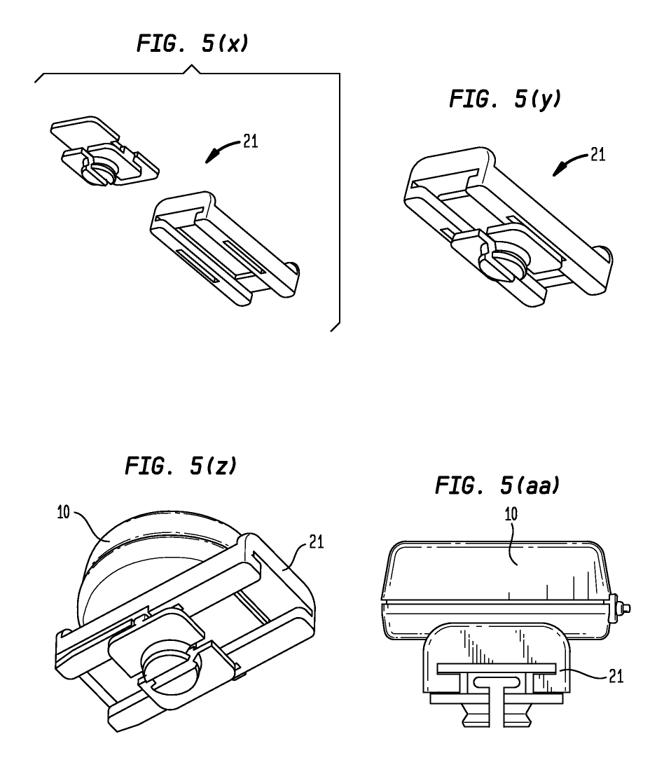

Referring now to FIGS. 5(a) through 5(aa), there are shown various embodiments of hearing aid attachments and abutments that permit conventional BAHA®-type hearing aids to be used in conjunction with magnetically-coupled hearing aids 10 and spacers 50, or alternatively for magnetically-coupled hearing aids 10 to be employed in conjunction with BAHA®-type abutments 15 that extend through a patient's skin 75. In one embodiment, a bone-anchored hearing aid (BAHA) universal adaptor 21 is provided that may be attached to a conventional abutment 15. See FIGS. 5(a) through 5(d), for example. In such embodiments, adaptors 21 or abutments 18 are useful for connecting an external portion of a bone-conducting hearing aid 10, such as an external audio processor, to different manufacturers' implanted abutments 15, or to internal implanted magnets 60. In such a manner, the customer can use an audio processor from a manufacturer that is not necessarily the manufacturer of abutment 15 or implanted magnets 60.

FIGS. 5(a) and 5(d) show two different types of BAHA®-type abutments 18 and corresponding bone screws 15 known in the art, and which may be used in conjunction with base plates 50 and adaptors 21 shown in FIGS. 5(b) and 5(c). A COCHLEAR® BAHA abutment 18 may have the two geometries shown in FIGS. 5(a) and 5(d), where a bone conduction hearing device 10 connects to abutment 18 through a male barb 22 that snap fits to the inside of abutment 18.

In contrast to the BAHA geometry shown in such Figures, the OTICON® device uses an external radial force to press against the outside of the abutment, as shown in FIGS. 5(e) and 5(f). This works well for the upper BAHA® abutment geometry of FIG. 5(e), but does not work well for the lower “tulip” shaped geometry of FIG. 5(f). Further examples are shown of various devices and methods by which the abutment connector can be secured to the BAHA® or OTICON® abutments by different mechanisms in FIGS. 5(g) through FIG. 5(aa). Whereas BAHA® technology basically uses a snap fit to have radial force pushing out from the inside and the OTICON® technology uses force to push on the abutment 18 from the outside, several examples are provided herein where pressure is applied in the axial direction to hold the adaptor 21 to the abutment 18 (see, e.g., FIGS. 5g) through 5(w). A centering feature may also be provided, in addition to a spring.

See also, for example, U.S. Pat. No. 7,021,676 to Westerkull entitled “Connector System” and U.S. Pat. No. 7,065,223 to Westerkull entitled “Hearing-Aid Interconnection System,” both of which disclose bone screws and abutments that may be modified in accordance with the teachings and disclosure made herein, and both of which are hereby incorporated by reference herein, each in its respective entirety.

Note that there are currently three BAHA® technologies on the market: COCHLEAR® (BAHA®), OTICON®, and SOPHONO® (OTOMOMA®). Each employs a different mechanism for holding the external audio processor to the side of the head. So that customers can use an audio processor from a different manufacturer with different abutments, universal adaptors 21 are useful. Such universal adaptors 21 permit a hearing aid patient not to be locked into using the external hearing aid portion made by the manufacturer of the abutment 18, thereby providing additional flexibility to the patient.

One embodiment of universal adaptor 21 uses a magnetic spacer plate 50 with an additional geometry that BAHA® and Ponto Pro® abutments can snap into. Such a magnetic spacer plate 50 may be provided in a range of magnetic strengths and/or spacings to accommodate the need for a range of retention forces for different patients. See, for example, FIG. 5(b).

A second type of universal adaptor has a geometry on one end that fits into (or onto) the BAHA® and/or PONTO PRO® abutment 18, with a second end (or feature) to facilitate magnetic attachment thereto. See, for example, FIGS. 5(c) and 5(d).

Functionally, percutaneous bone anchored implants provide adequate performance for those patients who use them. Practically they have many problems. Investigators note that between 10% and 30% of bone anchored implants have infections, fail to achieve osseointegration, are overgrown with tissue, and/or must be re-operated on in order to maintain functionality. Disclosed herein are various devices for use with hearing aids, including bone-conduction hearing aids, and methods related thereto. For example, various devices and related methods are provided for promoting osseointegration of the percutaneous portion of the bone-conducting hearing aid and/or that are actively antiseptic. In one embodiment, the invention relates to a coated percutaneous bone screw with materials that are antibiotic and/or stimulate bone growth, such as silver. In another embodiment, an electric current is employed to provide electrical stimulation to the bone and tissue, thereby increasing bone growth. In another embodiment, the invention relates to methods for using any of the devices provided herein to promote antisepsis and/or osseointegration.

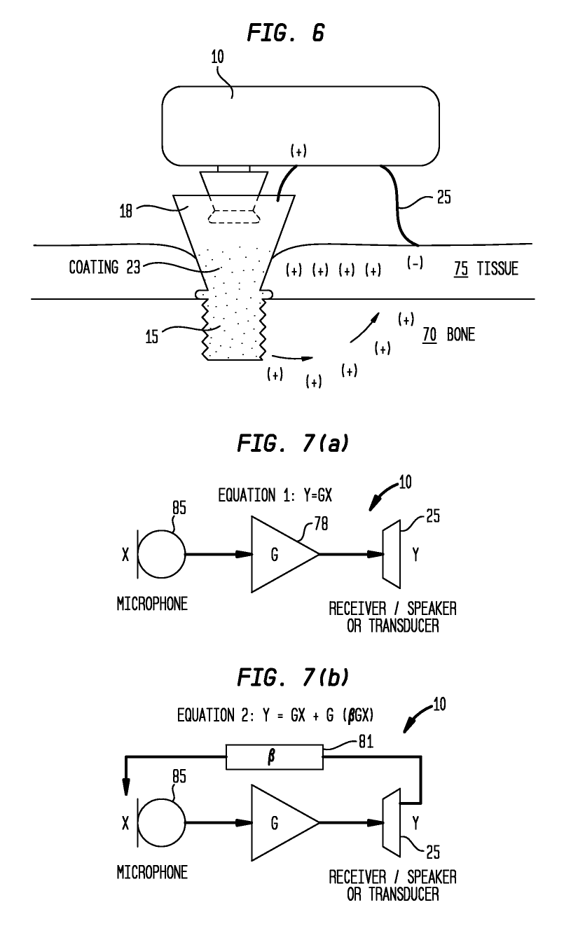

FIG. 6 shows one embodiment of a bone anchored hearing device 10 with a percutaneous bone screw 15 coated with an antisepsis and/or osseointegration-promoting material or coating 23. Device 10 includes a current generator for passing current through bone 75 and tissue 70.

One method for promoting antisepsis and/or osseointegration is by coating the percutaneous bone screw with material 23 that are antibiotic and/or stimulate bone growth. One example of a material 23 to promote bone growth is a hydroxyappitite with or without genetic growth factors. For purposes of providing antisepsis functionality, material 23 can include small amounts of silver or silver ions. In one aspect, a percutaneous bone anchored element (e.g., a bone screw 15) is coated with material 213. In another aspect, the bone anchored element 15 is used percutaneously to affix an externally worn hearing aid 10 to skull 75.

Another method relates to passing a small current through bone screw 15 via an external current generator incorporated into or apart from device 10. In such an embodiment, bone screw 15 acts as an anode (or cathode) and an electrical return path to the current generator complete the electrical circuit.

In yet another method for promoting antisepsis and/or osseointegration with respect to hearing aids or systems, there is provided ultrasonic stimulation. When applied to a bone anchor or a screw 15, an ultrasonic wave delivers mechanical pressure to the bone tissue at the implant site. Although the mechanism by which the low intensity pulsed ultrasound device accelerates bone healing is uncertain, it is thought to promote bone formation in a manner comparable to bone responses to mechanical stress. See, for example, the Sonic Accelerated Fracture Healing System (SAFHS®), manufactured by EXOGEN, Inc.®of West Caldwell, N.J., which accelerates the healing of new bone fractures in the tibial diaphysis and Colles' fractures of the distal radius in adults, and which was approved by the Food and Drug Administration (FDA) in October, 1994. FDA approval of the device was based in part on its review of two multicenter randomized controlled trials of the device on tibial diaphyseal fractures and distal radius (Colles') fractures.

Ultrasonic bone growth stimulation has also been studied for accelerating healing of stress fractures. In a prospective, randomized, double-blind clinical trial, Rue, et al. (2004) ascertained if pulsed ultrasound reduces tibial stress fracture healing time. A total of 26 midshipmen (43 tibial stress fractures) were randomized to receive pulsed ultrasound or placebo treatment. Twenty-minute daily treatments continued until patients were asymptomatic with signs of healing on plain radiographs. The groups were not significantly different in demographics, delay from symptom onset to diagnosis, missed treatment days, total number of treatments, or time to return to duty. Findings of this study demonstrated that pulsed ultrasound did not significantly reduce the healing time for tibial stress fractures. Furthermore, Zura and colleagues (2007) surveyed the attitudes of members of the Orthopaedic Trauma Association (OTA) concerning the use and effectiveness of bone growth stimulators. A questionnaire regarding bone growth stimulators was sent to the active members of the OTA. Descriptive statistics was performed using frequencies and percentages. All analyses were performed using Stata for Linux, version 8.0 (Intercooled Stata, Stata Corporation; College Station, Tex.). A response rate of 43% was obtained. Respondents indicated that they only occasionally used bone stimulators for the treatment of acute fractures and stress fractures. A majority of respondents have utilized stimulators for the treatment of delayed unions and non-unions. The authors concluded that many members of the OTA utilize bone stimulators for delayed unions and non-unions, but not routinely for the treatment of acute fractures or stress fractures.

Watanaba and colleagues (2010) stated that low-intensity pulsed ultrasound is a relatively new technique for the acceleration of fracture healing in fresh fractures and non-unions. Ultrasonic frequencies in the range of 1.5 MHz were provided, with a signal burst width of 200 microns, a signal repetition frequency of 1 kHz, and an intensity of 30 mW/cm2. In 1994 and 1997, 2 milestone double-blind randomized controlled trials revealed the benefits of pulsed ultrasound for the acceleration of fracture healing in the tibia and radius. They showed that pulsed ultrasound accelerated the fracture healing rate from 24% to 42% for fresh fractures.

According to one embodiment, ultrasonic treatment to promote antisepsis and/or osseointegration is accomplished by incorporating ultrasonic wave generation and delivery means into hearing device or system 10. In other embodiments, ultrasonic wave generation and delivery means are provided separate and apart from hearing aid or system 10.

Bone conduction hearing device 10 functions by accepting a signal from microphone 85, processing the signal, and then vibrating skull 75 with the acoustic frequency signal via transducer 25. Feedback can be a big problem, especially since it is desirable to have microphone 85 relatively close to transducer 25. This results in practical difficulty in accurately vibrating skull 75 in accordance with sound frequencies detected by microphone 85 that do not arise from transducer 25. Various mechanical methods can be employed to acoustically and vibrationally isolate microphone 85 from transducer 25.

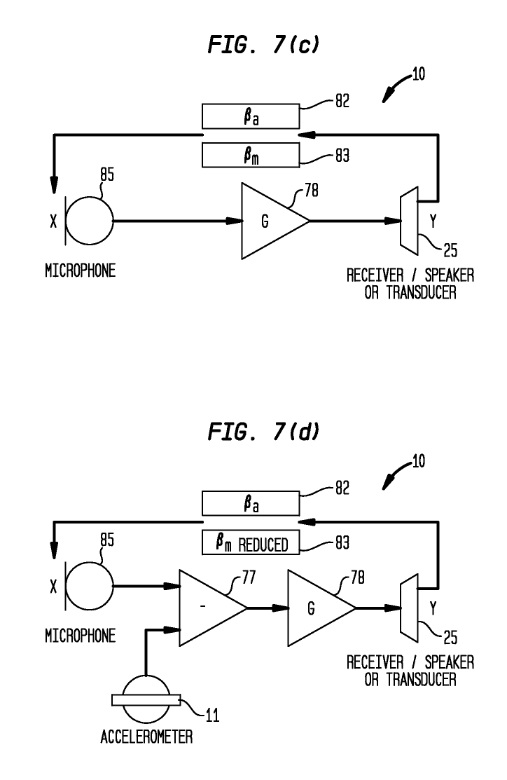

Referring now to FIGS. 7(a) through 7(d), disclosed herein are various devices and methods for the active cancellation of unwanted signals generated by transducer 25 from desired signals generated by microphone 85, thereby resulting in accurate and reliable transduction of the desired signals.

According to one embodiment, active cancellation for a bone conduction hearing device is provided by using a reference microphone or accelerometer that measures the signal generated by transducer 25. This measured signal is then flipped so it is approximately 180 degrees out of phase with that generated by transducer 25 and added to the signal generated by microphone 85. This reduces feedback and provides a higher fidelity and more reliable signal to skull 75.

According to another embodiment, active cancellation for a bone conduction hearing device is provided by using a second electromagnetic transducer 25 such that a flipped signal generated thereby is provided as an input to microphone 85, thereby reducing feedback and providing a higher fidelity and more reliable signal to skull 75. In such an embodiment, the second transducer is smaller than the original or first EM transducer 25.

A sound system is any entity that takes a sound input and produces an output. Using that definition, a hearing instrument is a physical system that takes sounds (i.e., inputs), amplifies such sounds according to the hearing loss of the wearer (i.e., processing) so that the signals output by the hearing aid have an at an appropriate loudness for the wearer. Consequently, one can describe the behaviors of a hearing instrument using concepts that are commonly used in engineering control system theory.

What follows is a simplified quantitative description of why and what happens when feedback occurs.

FIG. 7(a) shows a simple block diagram of a hearing instrument or device 10. The input signal (X) is amplified by a gain factor (G) in amplifier 78 that results in an output signal (Y) that is provided to EM transducer 25. If hearing device 10 has no feedback path, which (in the case illustrated in FIG. 7(a) corresponds to total acoustic and mechanical isolation of microphone 85 and transducer 25), output signal (Y) is determined by the gain of hearing instrument 10 (and amplifier 78) and the input level (X). That is, Y=GX. See FIG. 7(a).

When a feedback path is present, a certain fraction (β) of the output signal will leak back to microphone 85, as shown in FIG. 7(b), where a simple block diagram of a hearing instrument 10 that allows some of the amplified sound to leak back to microphone 85 is shown. That is, device 10 of FIG. 7(b) has a feedback path. One can consider the feedback process as a looped sequence of events. First, input signal X creates an output GX. During the first loop, a certain fraction (β) of the output signal GX will leak back to microphone 85 and contribute to the input as βGX. Thus, the combined input at microphone 85 is then (X+βGX). Subsequently, that signal will be amplified by a factor G and contribute to the output signal. As a result, the output of hearing instrument 10 of FIG. 7(b) becomes output loops back to microphone 85, the output becomes progressively larger by a factor of Gβ. After n loops, the output of the hearing instrument becomes Y=GX [1+(Gβ)+(Gβ)2+ . . . +(Gβ)n]. The foregoing equation is an example of a power series and can be simplified to Y=GX/(1−Gβ). An intuitive way of understanding this power series is to consider that output signal Y consists of two components. The first component is the amplified input signal, and the second component is the amplified feedback signal. The amplified input signal equals the input signal multiplied by the gain of the amplifier G (per the basic hearing instrument diagram in FIG. 7(a)). The feedback signal equals the fraction β of the output signal Y (see FIG. 7(b)). This feedback signal is picked up by microphone 85 and amplified by a factor G, which contributes to the resulting output signal as GβY. That is, the output of hearing aid or device 10 is Y=GX+GβY. By moving GβY to the left side of the equation and simplifying, we have Y(1−Gβ)=GX, which, by dividing both sides by (1−Gβ), provides the same result set forth above, or Y=GX/(1−Gβ). This equation is fundamental to understanding the factors controlling feedback in hearing aid 10. Note that without the denominator the foregoing equation is identical to that described above in connection with FIG. 7(a) for a hearing aid 10 having no feedback path. Thus, the denominator describes the feedback properties of a hearing aid. The elements in the denominator, G and β, form the loop gain Gβ (or open loop gain) which is the main determinant of possible feedback problems in a hearing instrument system 10.

Loop gain is controlled by the gain (G) of the hearing instrument, which is why feedback can sometimes be eliminated by reducing gain. On the other hand, the magnitude of β is affected by many factors that may or may not be controllable.

Disclosed herein is a design where a component such as an accelerometer provides inputs that are used to adjust or set βₘ. Such an input may be, by way of example, one that measures unwanted system vibration provided by EM transducer 25, and hence actively attempts to cancel such undesired contributions to the audio signal provided to the patient. See FIGS. 7(c).

FIG. 7(d) illustrates one embodiment of device 10 where accelerometer 11 is positioned right next to microphone 85, and senses the vibrations induced by the overall system (and especially EM transducer 25) so that undesired signals associated with the mechanical components thereof can be subtracted out from the amplified signal and reduce feedback signal. The feedback operations described above may be implemented in DSP 80, or in a separate feedback loop and device. Also contemplated herein are adaptive feedback control and digital filtering algorithms, methods and devices that promote active noise cancellation.

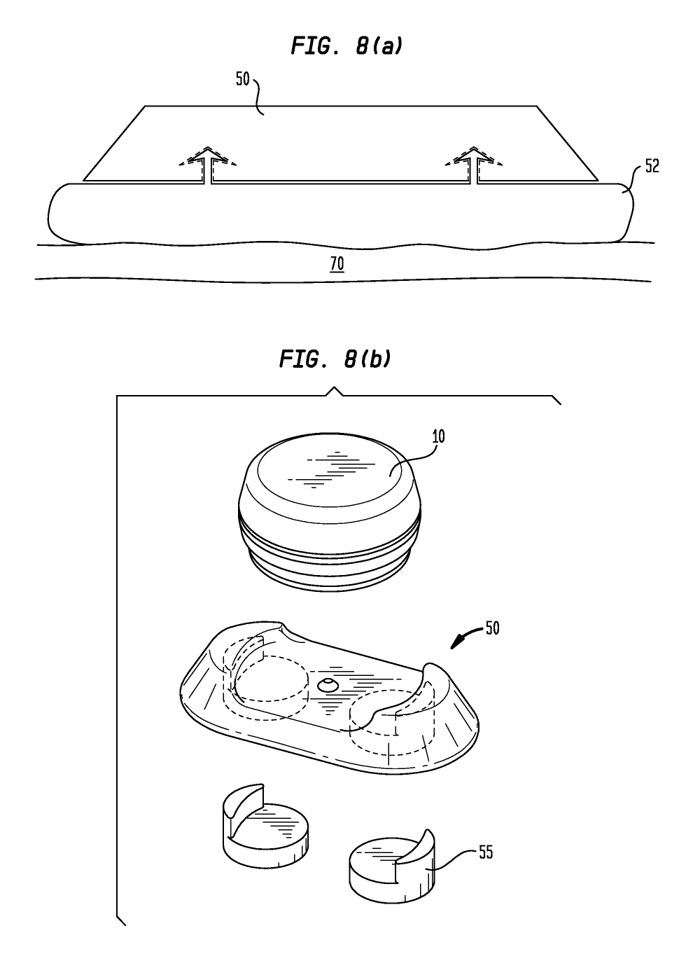

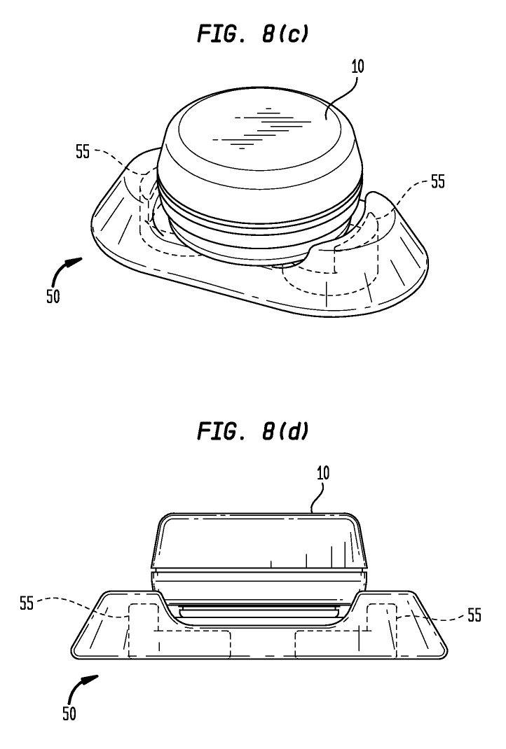

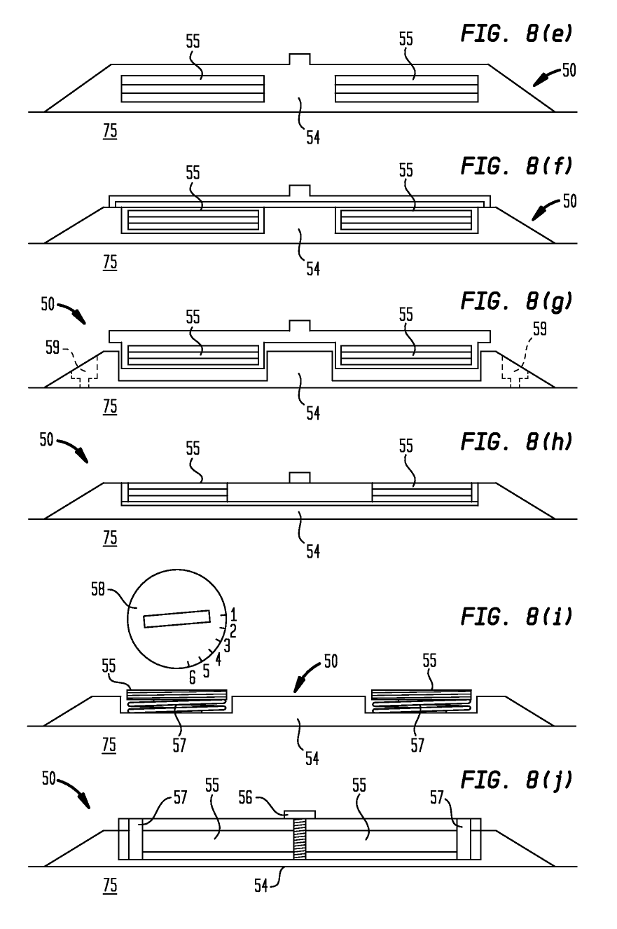

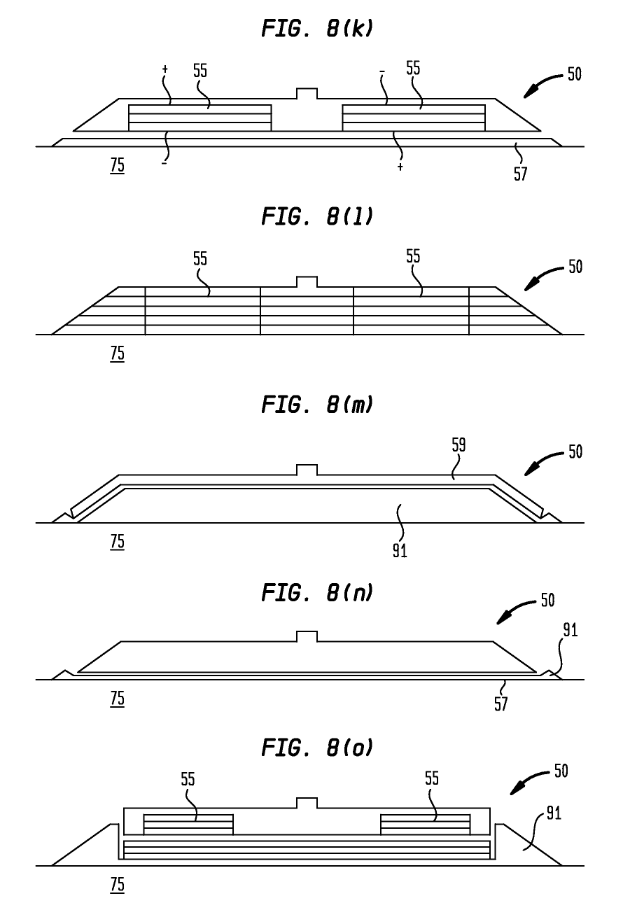

Referring now to FIGS. 8(a) through 8(o), there are shown various embodiments of spacers or base plates 50 for use in conjunction with magnetically coupled hearing device 10. For example, spacers 50 are provided that are specially contoured for better contact with patient's skin or tissue 75, particularly in the region of the skull shape underlying the desired skin contact region. In one embodiment, spacer 50 is magnetic and is positioned over skin 75. In another embodiment, spacer 50 is magnetic and is positioned under skin 75. Spacer 50 may be formed from one material, or may be formed from two or more materials.

In one embodiment, spacer 50 disclosed herein may have a low-profile. In another embodiment, spacer 50 is both low-profile and custom-contoured to patient's skin 75 (e.g., the skull shape underlying the desired skin contact region). In another embodiment, spacer 50 comprises magnets 55 that are shaped to fit cut-outs or magnet receiving regions in spacer 50, thereby providing spacer 50 having a low profile, even when more than one magnet is used. The spacing of magnets 55 from the surface of skull 70 may be variable, allowing adjustment of the magnetic retention force by adjusting the spacing of magnets 55.

Referring now to FIG. 8(a) , there is shown one embodiment of a custom contoured magnetic spacer 50 having conforming membrane or membrane 52 attached to a lower portion thereof, and which is configured to conform to the shape of a patient's head in the region above the implant 20 in skull 70. For best sound transmission between audio processor 10 and skull 75, magnetic spacer 50 must have good contact with patient's skin 70. However, if spacer 50 and skin 75 do not have the same corresponding contours, unwanted pressure points and abrasion between skin 75 and spacer 50 can cause sore spots on the patient's skin. This problem is solved by the embodiment illustrated in FIG. 8(a), and may also be solved by employing in spacer 50 a flexible or hinged plate, or a spacer 50 comprising a soft or compliant material 52 which conforms to the patient's head and then “cures” or hardens according to such contours after being placed in position. Various hardening methods are available, including hardening mediated via one or more of: temperature, oxygen (curing, light, polymerization or polymeric reaction, and two-part epoxies. Alternatively, spacer 50 can comprise two or more materials with one such material being configured to conform to the patient's head and being curable as discussed above. If spacer 50 and conforming material 52 form more than one component, a specific geometry can be employed to hold the conforming material 52 to the spacer 50. For instance, a tortuous path or a negative barb can be molded into the spacer as shown in FIG. 8(a). When conforming material 52 is placed on spacer 50, material 52 hardens in place and is thereby connected to spacer 50.

In another embodiment, a low-profile magnetic spacer is provided as shown in FIGS. 8(b), 8(c) and 8(d). For cosmetic and safety reasons it is important to keep the hearing device 10 in as low a profile as possible against the side of the patient's head. However, if multiple magnets are needed for increased holding strength, then the hearing device may become correspondingly larger and farther away from the patient's skull 70. FIGS. 8(b), 8(c) and 8(d) show one embodiment of a hearing device system where device 10 is configured to be received in central portions of spacer 50, and where spacer 50 is configured to receive magnets 55 at either end thereof. Shaped magnets 55 are configured to fit within the outer shoulders of spacer 50, which sit above the lowermost portions of hearing device 10, thereby conserving valuable volume and permitting device 10 to be placed as close as possible to patient's skin 70 and skull 75. Magnetic spacer 50 features a central cut-out or recess for device 10, and uses shaped magnets 55 around the periphery thereof for increased holding strength without increasing the profile of the device when used by the patient.

In other embodiments, variable spacing magnetic spacers 50 are provided, as shown in FIGS. 8(e) through 8(j). The thickness of skin 75 over a temporal bone can vary from less than 2 mm to over 8 mm, which can significantly affect the retention force created between implanted and external magnets 60 and 55. Additionally, a given patient may desire variable retention force to accommodate different activities (e.g., a child might use a lower retention force during class but a stronger retention force during play time). A number of different embodiments of spacer 50 are disclosed herein that permit variation of the distance between magnets 55 of magnetic spacer 50 and the surface of the patient's head.

FIGS. 8(f), 8(g), 8(h), 8(i) and 8(j) show various embodiments of magnetic spacers 50 that permit variation of the distance between magnets 55 and skin 75 using: (a) a “standard” magnetic spacer 50 with a stack of magnets 55 embedded in a rigid material (see FIG. 8(e)); (b) a multi-piece spacer 50 with a cap and base having a stack of magnets 55 between the cap and base, where the base thickness can be varied (see FIG. 8(f)); (c) a multi-piece spacer 50 having a cap and base, where magnets 55 are contained within the cap and base, and where thickness may be varied (see FIG. 8(g)); (d) a multi-piece spacer 50 with a cap and base, where magnets 55 are contained within the cap, and where the base thickness can be varied (see FIG. 8(h));. (e) a spacer 50 where magnets 55 are enclosed below threaded lids 58 and on top of spring elements 57, where the threaded lid may be turned inward or outward to compress springs 57 and vary the distance (see FIG. 8(i)); and (f) a spacer 50 with magnets 55 located on a moveable plate, the plate being mounted on guide pins, with a screw 56 threaded into the plate such that turning the screw will raise or lower the plate on the guide pins, thereby varying the distance (see FIG. 8(j)).

Further embodiments of spacers 50 are shown in FIGS. 8(k) through 8(o), which also permit variation of the distance between magnets 55 and skin 75. FIG. 8(k) shows one embodiment where a multi-piece spacer 50 is provided having a cap and base, where magnets 55 are contained within the cap, and where the base thickness can be varied. FIG. 8(I) shows an embodiment where a multi-piece spacer 50 having pairs of magnets 55 contained within their own plate is provided, and where the plates may be stacked to achieve different magnetic strengths. FIG. 8(m) shows an embodiment where a variation in thickness is provided by configuring caps 89 having different colors (and correspondingly different thicknesses). FIG. 8(n) shows an embodiment where spacer 50 comprises a flexible bag or balloon 91 on the bottom, which may be filled to various degrees using different materials and/or types of materials to vary the spacing . FIG. 8(o) shows an embodiment where multi-piece spacer 50 has a cap and base, where magnets are contained within cap, and where thin shim plates are stacked between the cap and base to achieve the desired spacing.

In yet another embodiment a custom contoured magnetic spacer 50 is provided where the surface of magnetic spacer 50 is in contact with skin 75 and forms a pliable membrane, formed, by way of example, from fabric or a thin plastic film. The space between the body of spacer 50 and membrane 91 may be occupied by a small granular substance or powder. Such substance or powder is configured to conform to the patient's anatomy, but also provides sufficient density and mechanical rigidity as to effect a suitable degree of mechanical coupling for vibration transfer from the main body of magnetic spacer 50 to the patient's skull 70.

In another embodiment, the surface of magnetic spacer 50 configured for contact with the patient is a pliable membrane 91, and the space between the body of spacer 50 and membrane 91 is occupied by a fluid or incompressible gel. Such a membrane is configured to provide sufficient compliance so as to conform to the patient's anatomy when typical magnetic retention forces are applied. Those same forces extend the membrane to or near the limits of its compliance such that the membrane and the fluid or gel contained therein provide effective vibration transfer from the main body of the spacer 50 to the patient.

In still other embodiments, a 1-3 mm thick foil forms a portion of the footprint outline or bottom membrane of spacer 50, and may be pre-assembled to stick to the bottom of spacer 50. A protective tape may be placed over the film and peeled off when spacer 50 is ready to be used. Spacer 50 is then stuck onto skull 70 of the patient, where it is held in place with implanted magnets 60. The foil conforms to the patient's anatomy and deforms plastically with respect to the contour of the skull surface to become firm and cure, preferably within minutes. Such a foil could comprise 2 foils, i.e. the 2 components of a 2 component curable epoxy that is biocompatible. An air-curable or UV-curable polymer may also be used. Such foils or polymers have the objective of eliminating the typical 1-3 mm unevenness in the contours of skull 75 in the vicinity of implant 20, and thereby provide improved sound transmission and fewer issues with pressure points. Such membranes 91 can also comprise gelled films or bandages, and two-film epoxies.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

The above-described embodiments should be considered as examples of the present invention, rather than as limiting the scope of the invention. In addition to the foregoing embodiments of the invention, review of the detailed description and accompanying drawings will show that there are other embodiments of the present invention. Accordingly, many combinations, permutations, variations and modifications of the foregoing embodiments of the present invention not set forth explicitly herein will nevertheless fall within the scope of the present invention.

We claim:

1. A hearing system, comprising:
an external audio processor comprising a magnetic spacer, and
an implantable array of a plurality of magnets;
wherein the magnetic spacer and implantable array are configured to permit the audio processor to be magnetically coupled to a skull of a patient when the implantable array is implanted in the patient's skull, and further wherein a position of the audio processor on the patient's skull may be modified by the patient in accordance with a geometry of the plurality of magnets in the array.

2. A hearing system, comprising:
an external audio processor comprising a microphone, an electromagnetic (EM) transducer, and an accelerometer configured to sense mechanical vibrations generated by the transducer;
wherein the audio processor further comprises feedback control means for actively cancelling noise associated with the mechanical vibrations and removing or cancelling same from signals measured by the microphone, such means employing output signals from the accelerometer to actively cancel such noise.

3. A hearing system, comprising:
an external audio processor comprising a magnetic spacer;
an implantable array of a plurality of magnets;
wherein the magnetic spacer is configured to permit a thickness thereof or a magnetic strength or force associated therewith to be adjusted by a patient.
